(19) United States
(12) Patent Application Publication
(10) Pub. No.: US 2005/0254234 A1
(43) Pub. Date: Nov. 17, 2005

(54) LED flashlight

(76) Inventor: Kuo-Tsai Wang, Yun Kan City (TW)

Correspondence Address: PRO-TECHTOR INTERNATIONAL, 20775 Norada Court, Saratoga, CA, 95070-3018, US

(21) Appl. No.: 10/848,099

(22) Filed: May 17, 2004

(51) Int. Cl. F21L 4/02

(52) U.S. Cl. 362/184; 362/202; 362/205

(57) ABSTRACT

An LED flashlight includes a cylindrical shell, an electric circuit board, a position base, a conductive disk, a battery base, a front lid and a rear lid. The cylindrical shell consists of a lamp cover, a shell body and a bottom cap. The lamp cover has a light-focusing lens, a light-focusing base and a lamp base in its interior. The shell body has a position base, a conductive disk, a battery base and the front lid and the rear lid in its interior. The position base has a push button connected with the electric circuit board, and the conductive disk is fixed behind the position base, connected with the electric circuit board. The battery base is fixed between the front lid and the rear lid, having three grooves formed in parallel for receiving batteries. The push button controls turning on or off the plural LED to be lit up continually or on-and-off.

### BACKGROUND OF THE INVENTION

1. Field of the Invention

This invention relates to an LED flashlight, particularly to one having plural batteries placed in parallel and connected in series so as to shorten the needed length of a flashlight, to have stable conductivity, provided with a no-stage changeover switch connected with an IC to enable a lamp to lit up strongly and continually or on-and-off.

2. Description of the Prior Art

A conventional flashlight generally uses traditional tungsten filaments for emitting light, but its light is weak and impossible to reach far. So some flashlights nowadays have come to use LED lamps instead for reinforcing its Light, but however, LED lamps need high voltage and low current as its power, impossible to emit light in case of less than 4.5V power. And each dry battery only has 1.5V so that the LED lamp may need three dry batteries connected in series, with the length of a flashlight having to have a long length if using an LED lamp. Then the flashlight -may be quite inconvenient to store, transport or carry along because of its length.

### SUMMARY OF THE INVENTION

This invention has been devised to offer an LED flashlight with a short length and strong conductivity, stabilized in its strong light.

A first embodiment of the LED flashlight according to the present invention includes a cylindrical shell consisting of a shell body, a lamp cover and a bottom cap, an electric circuit board having an IC, a position base having a push button of a no-stage changeover switch, a conductive base having a center positive circle and a negative outer circumferential ring, a battery base having three parallel grooves for three dry batteries, a front lid, and a rear lid.

The LED flashlight has a positive route and a negative route formed by the positive circle and the negative outer circumferential ring of a conductive disk, a pair of input positive and negative pins of the electric circuit board in the lamp cover, the positive and the negative of a push button connected with the changeover positive and negative pins of the electric circuit board so the push button turns on and off the power of the three batteries to light up the LED lamps continually or on-and-off so the light may pass through focusing lens placed in the lamp base in the lamp cover. As the three dry batteries are located in parallel in the battery base, the whole length of the LED flashlight is shortened in a great extent for convenience of storing, transporting and carrying.

A second embodiment of the LED flashlight according to the present invention has an additional metal conductive ring fitted around the position base, and the metal conductive ring has saw teeth formed fully on its outer surface for firmly contacting the inner surface of the loam cover,

Further, a third embodiment of the LED flashlight according to the present invention has a metal conductive ring fitted around the position base, and the metal conductive ring has saw teeth formed fully on its outer surface for firmly contacting the inner surface of the lamp cover. Further, the shell body is much longer than that in the first and the secoond embodiment so the three batteries are located in a straight line, not in parallel as in the first and the second embodiment.

### BRIEF DESCRIPTION OF DRAWINGS

This invention will be better understood by referring to the accompanying drawings, wherein:

FIG. 1 is an exploded perspective view of a first embodiment of an LED flashlight in the present invention;

FIG. 2 is a side cross-sectional view of the first embodiment of an LED flashlight in the present invention;

FIG. 3 is a rear view of an electric circuit board for the lamp base in the first embodiment of an LED flashlight in the present invention;

FIG. 4 is a circuit view of an IC on the electric circuit board in the first embodiment of an LED flashlight in the present invention;

FIG. 5 is a side view of a front lid and its positive conductor in the first embodiment of an LED flashlight in the present invention;

FIG. 6 is a side cross-sectional view of the positive conductor in the first embodiment of an LED flashlight in the present invention;

FIG. 7 is an exploded perspective view of a second embodiment of an LED flashlight in the present invention;

FIG. 8 is a side cross-sectional view of the second embodiment of an LED flashlight in the present invention

FIG. 9 is an exploded perspective view of a third embodiment of an LED flashlight in the present invention; and,

FIG. 10 is a side cross-sectional view of the third embodiment of an LED flashlight in the present invention.

### DETAILED DESCRIPTION OF THE PREFERRED EMBODIMENT

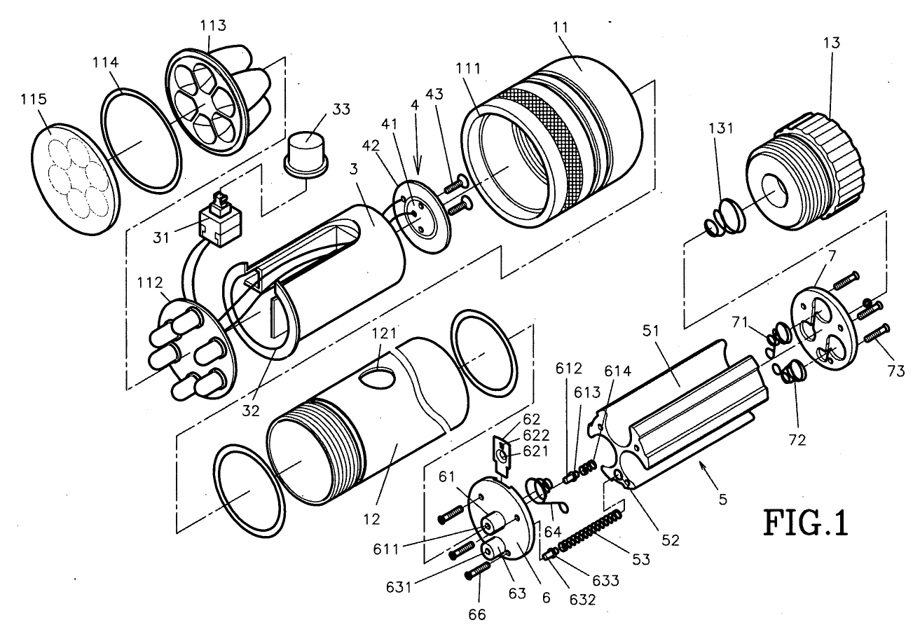

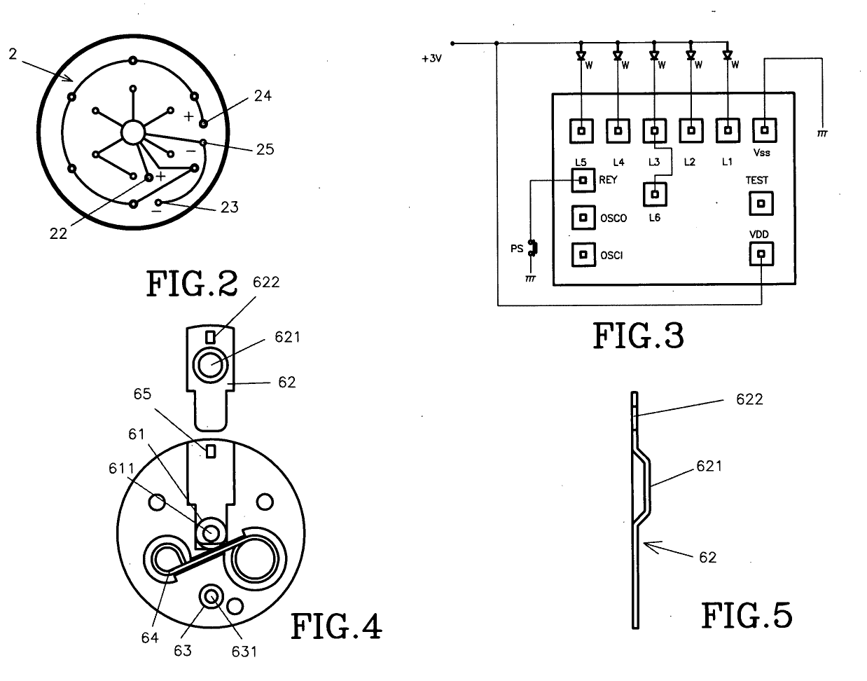

A first embodiment of an LED flashlight in the present invention, as shown in FIGS. 1 and 2, includes a cylindrical shell 1, an electric circuit board 2, a position base 3, a conductive disk 4, a battery base 5, a front lid 6 and a rear lid 7.

The cylindrical shell 1 consists of a lamp cover 11 a shell body 12, and a bottom cap 13. The lamp cover 11 has an inner annular engage edge 111, and a lamp base 112, an O-shape ring 114 and a light focusing lens 115 are orderly arranged in the lamp cover 11 by pushing them through the inner annular engage edge 111.

The position base 3, the conductive disk 5, the front lid 6 and the rear lid 7 are placed in the cylindrical shell 1. The shell body 12 has a hole 121 in its annular wall, and a helical push spring 131 is placed in the bottom cap 13.

The electric circuit board 2, as shown in FIGS. 3 and 4, is combined on the light base 112, provided with an IC 21 fixed in the center, an input positive pin 22, an input negative pin 23, a changeover positive pin 24 and a changeover negative pin 25.

The position base 3 is cylindrical and provided with a flange 32 formed at the front end to contact firmly with the lamp base 112, and positioned in the shell body 12. On the outer surface of the position base 3 is glued a push button 31 of no-stage changeover switch connected electrically with the pair of the changeover positive and negative pins 24 and 25.

The conductive disk 4 is fixed behind the position base 3, formed as two surfaced conductive pc board with a positive circle 41 formed in the center and a negative ring 42 formed at the circumferential edge and respectively connected with the input positive pin 22 and the input negative pin 23 with wires.

The battery base 5 has its front end fixed with the front lid 6, its rear end fixed with the rear lid 7, and three parallel lengthwise semicircular grooves 51 for receiving three batteries therein, and a lengthwise hole 52 for receiving a negative coil spring 53 therein.

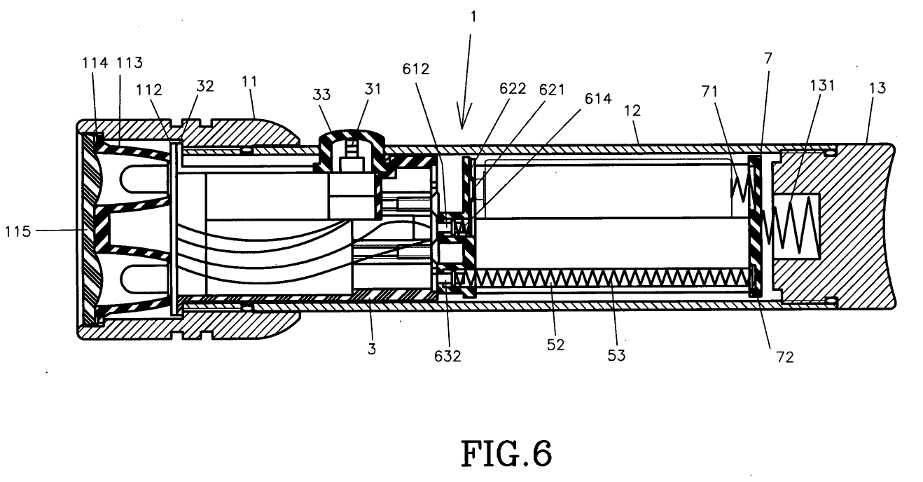

The front lid 6 as shown in FIGS. 5 and 6, has a first projecting small rod 61 at a front side center, which has an opening facing rearward and a small hole 611, receiving a small contact rod 612 with a flange 613 and a small spring 614 in its interior. The small contact rod 612 has its rear end fitting in the small spring 614, and the flange 613 just located between the small spring 614 and the small hole 611. Further, a positive member 62 is sealed on the opening of the first projecting small rod 61, letting the small spring 614 push the small contact rod 612, which has its front end exposing out of the small hole 611. Further, the positive member 62 has its lower portion functioning to prevent the small spring 614 from loosening and falling off, its intermediate portion provided with a positive surface 62 1 protruding rearward, and its upper portion provided with a mortise 622 to engage tightly with a tenon 65 formed at the rear side of the front lid 6. Moreover, the front lid 6 further has a second projecting small rod 63 below the first projecting small rod 61, and the second projecting small rod 63 has an opening facing rearward, and a small hole 631 in the front side so that an intermediate flange 633 of another contact rod 632 may fit in the second projecting small rod 63 and have its front end exposing out of the small hole 631 and its rear end fitting in the front end of the negative spring 53 of the battery base 5. Further, the intermediate flange 633 is just located between the negative spring 53 and the outer circumference of the small hole 631. And a helical spring 64 is additionally provided between the first projecting rod 61 and a second projecting rod 63 to function as a conductor.

The rear lid 7 has a helical series spring conductor 71 and a helical negative spring conductor 72 connected with the rear end of the negative spring 53.

In assembling, the lamp cover 11 screws with the cylindrical shell 12 at first, and the two screws 43 are used to fix the conductive disk 4 with the rear side of the position base 3, with the positive circle 41 and the negative ring 42 connected with the pair of the input positive and negative pins 22 and 23 of the electric circuit board 2. Next, the push button 31 is glued firmly with the position base 3, with the positive and the negative wires of the push button 31 connected with the pair of the changeover positive and negative pins 24 and 25 of the electric circuit board 2. Then the conductive disk 4 together with the position base 3 and the push button 31 are pushed into the front portion of the shell body 12, with the push button 31 protruding out of the hole 121 of the shell body 12, and a waterproof stop 33 is fitted in and closes up the hole 121. Then the light focusing base 113, the O-shaped ring 114 and the light focusing lens 115 are orderly placed in the front portion of the lamp base 112, with the light focusing lens 115 forcefully pressed in the engage edge 111 of the light cover 11 to keep those components stable. Further, the battery base 5 is fixed with the front and the rear lids 6 and 7 by means of two groups of three screws 66 and 73, located in the rear portion of the cylindrical shell 12. Next, the bottom cap 13 is screwed with the shell body 12, and three dry batteries are fitted in the three grooves 51 of the battery base 5, and the series conductors 64 and 71 of the front and the rear lids 6 and 7 are placed in series with the three battery, with the positive route is formed with the positive member 62, the small spring 614 in the projecting rod 61, and the contact rod 612 and the positive circle 41 of the conductive disk 4. The negative route is formed with the negative conductor 72 of the rear lid 7, the negative spring 53 of the battery base 5, the contact rod 632 in the second projecting small rod 63 and the negative ring 42 of the conductive disk 4. The conductivity of the LED flashlight is stable because of the helical push spring 131 of the bottom cap 13 forcefully pushing the components positioned in front of the helical push spring 131. In addition, the IC 21 of the electric circuit board 12 with cooperation of the push button 31 of the no-stage changeover switch can control the LED lamp to be lit up continually or on-and-off, and to be turned off in various modes.

In using the push button 31 for turning on or off the LED lamps, pushing down the key of the push button 31 once lights them up continually, pushing down the key twice turns them off, pushing down the key thrice lights them up on-and-off, and pushing down the key fourth turns off the LED, and so forth.

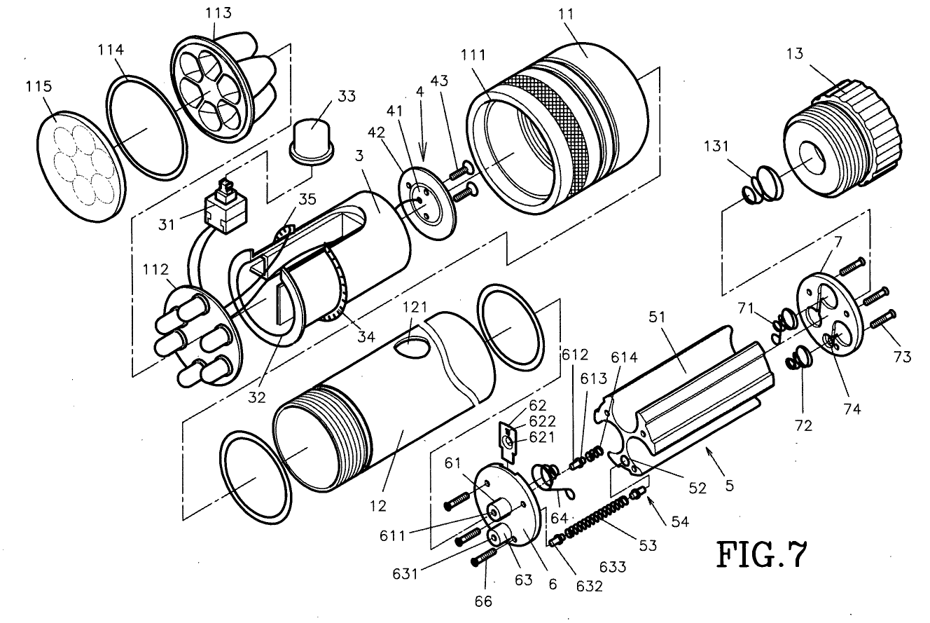

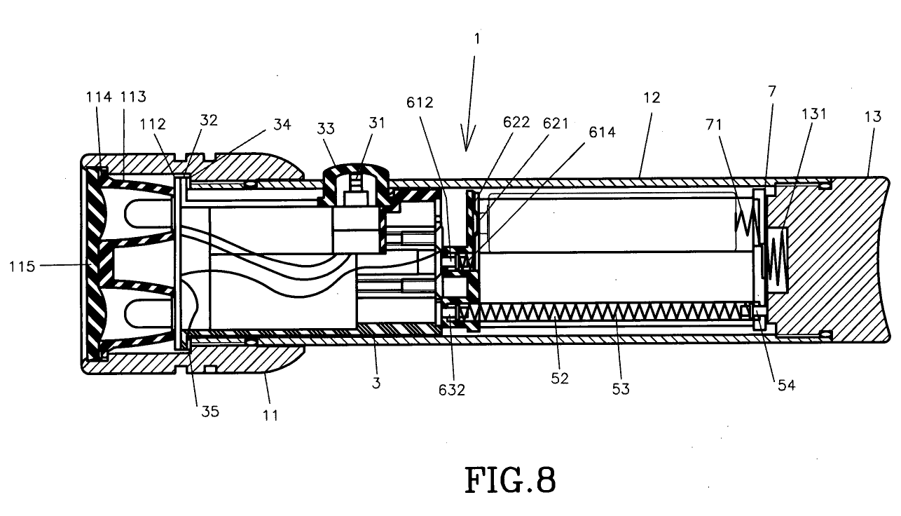

Next, FIGS. 7 and 8 show a second embodiment of an LED flashlight, having a different structure from the first one in a conducting ring 34 additionally provided to fit around the intermediate portion of the position base 3. The conducting ring 34 has its rear side contacting the opening of the cylindrical shell 12, and saw teeth 35 formed fully on an outer surface, and the outer diameter of the saw teeth 35 is a bit larger than the inner diameter of the lamp cover 11 and contacts tightly with the inner surface of the lamp cover 11. The conductive ring 34 is connected with wire with the input negative pin 23 the electric circuit board 2, but the negative ring 42 is not connected with the input negative pin 23 with wire. Further, a projecting small rod 54 is additionally provided at the rear end of the negative spring 53, and a small hole 74 is additionally bored in the rear lid 7 to face to the negative spring 53 so the contact rod 54 can expose out of the small hole 74, and connect with the bottom cap 13. Then the negative route is formed from the negative conductor 72, the contact rod 54, the bottom cap 13, the lamp cover 11, and the conductive ring 34 to the input negative pin 23 of the electric circuit board 2.

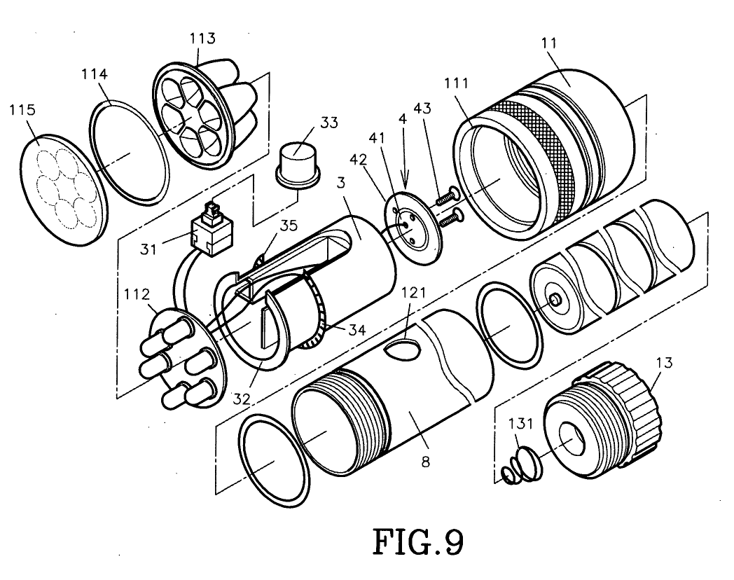

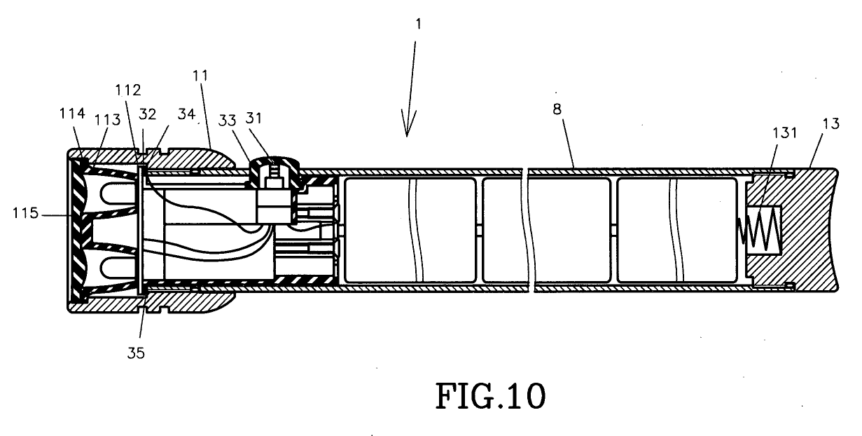

Next, FIGS. 9 and 10 show a third embodiment of an LED flashlight, which has the same structure as the second embodiment, includes the conductive ring 34 fitted around the position base 3 and connected with the input negative pin 23 of the electric circuit board 2, but the negative ring 42 of the conductive disk 4 is not connected with the input negative pin 23 of the electric circuit board 2. The position base 3 and the conductive disk 4 are placed in a front section of a cylindrical shell 8, which is of a longer length than the cylindrical shell 3 of the second embodiment, and three dry batteries are placed in a straight line in the rear portion of the cylindrical shell 8. Then the positive circle 41 of the conductive disk 4 is connected with the positive of the batteries, while the negative route is formed from the push spring 13 1 of the bottom cap 13 through the shell body 12, the lamp cover 11, the conductive ring 34 to the input negative pin 23 of the electric circuit board 2.

While the preferred embodiments of the invention have been described above, it will be recognized and understood that various modifications may be made therein and the appended claims are intended to cover all such modifications that may fall within the spirit and scope of the invention.

1. An LED flashlight comprising:
A cylindrical shell consisting of a shell body, a metal lamp cover, and a bottom cap screwed with said shell body, said lamp cover having a lamp base, a focusing lens base, an O-shaped ring and a light focusing lens orderly arranged in its interior:
An electric circuit board fixed on said lamp base, having an IC on its center portion, a pair of input positive and negative pins and a pair of changeover positive and negative pins:
A position base deposited in said shell body, having a push button on its upper side and a flange formed in its front end, said push button connected with the pair of positive and negative changeover pins of said electric circuit board:
A conductive disk fixed on a rear side of said position base, having a positive circle formed in its center portion and a negative ring formed on its outer circumference, said positive circle and said negative ring respectively connected with the pair of the input positive and negative pins of said electric circuit board:
A battery base having its front side fixed with said front lid, its rear side fixed with said rear lid, three semicircular grooves separated in parallel to one another for receiving three dry batteries therein, and a lengthwise hole for receiving a negative spring therein:
Said front lid having a first projecting small rod extending from a rear side to a front side in the center section and bored with an opening in the rear side, and a small hole formed in the front side, a contact rod and a small spring being placed in said first projecting rod, said contact rod exposing out of said small hole, a positive member sealing the opening of said first projecting rod, a second projecting rod provided below said first projecting rod on said front lid and having an opening in a rear side and a small hole in a front side, a contact rod placed in said second projecting rod and exposing out of said small hole and having a rear end fitting in a front section of said negative spring of the said battery base, a series conductor fixed on the rear side between said first and said second projecting rod: and,
Said rear lid having a series conductor and a negative conductor fixed on its front side, said negative conductor connected with said negative spring of said battery base.

2. The LED flashlight as claimed in claim 1, wherein said flange of said position base has its rear side contacting the opening end of said shell body and its front side pushing against and keeping said lamp base in place.

3. The LED flashlight as claimed in claim 1, wherein said conductive disk is a PC board with two conductive surfaces.

4. The LED flashlight as claimed in claim 1, wherein said first projecting rod of said front lid has a flange formed in an intermediate portion, which is located between the small spring and the outer circumference of said small hole.

5. The LED flashlight as claimed in claim 1, wherein said positive conductive member of said front lid has its lower portion fixing said small spring, its intermediate portion formed with a projecting-rearward positive surface connected with the positive of the batteries, and a lower portion provided with a mortise engaging with a tenon provided on a rear side of said front lid.

6. The LED flashlight as claimed in claim 1, wherein said contact rod placed in said second projecting rod of said front lid has a flange on an intermediate portion, which is located between said negative spring and the outer circumference of said small hole.

7. The LED flashlight as claimed in claim 1, wherein a metal annular projecting ring is fitted around the intermediate portion of said position base near said flange, said metal annular ring contacts the opening of said shell body and its upper surface provided fully with saw teeth, said saw teeth has its outer diameter a little larger than the inner diameter of said lamp cover and firmly contacts with the inner surface of said lamp cover, said metal annular ring connected with said input negative pin of said electric circuit board of said lamp base, said negative ring of said conductive disk not connected with said input negative pin of said electric circuit board; said rear lid is provided with a small hole facing said negative spring of said battery base; said negative spring in said small hole of said battery base has a contact rod firmly received in a rear end of said negative spring, and said contact rod protrudes out of said small hole to contact said bottom cap.
